(19) United States
(12) Patent Application Publication
(10) Pub. No.: US 2014/0242979 A1
(43) Pub. Date: Aug. 28, 2014

(54) CELLULAR NETWORK INTERWORKING INCLUDING RADIO ACCESS NETWORK EXTENSIONS

(71) Applicant: Broadcom Corporation, Irvine, CA (US)

(72) Inventors: Farouk BELGHOUL, Campbell, CA (US); Kamesh MEDAPALLI, San Jose, CA (US)

(73) Assignee: Broadcom Corporation, Irvine, CA (US)

(21) Appl. No.: 14/181,361

(22) Filed: Feb. 14, 2014

Related U.S. Application Data
(60) Provisional application No. 61/769,097, filed on Feb. 25, 2013.

(51) Int. Cl. H04W 28/02; H04W 88/06; H04W 36/00

(52) U.S. Cl. CPC H04W 28/0231; H04W 36/0083; H04W 88/06
USPC 455/426.1; 455/561; 455/553.1

(57) ABSTRACT

A communication device and method for offloading one or more communications from a communication network to one or more other communication networks. The offloading can be controlled by one or more service providers that instruct the communication device to perform the handoff of communications. For example, the one or more service providers can generate one or more commands that instruct the communications device to scan for one or more networks, identify one or more networks, analyze one or more of the identified networks, generate one or more reports based on the analysis, and/or provide the generated reports to the service provider(s).

### CROSS REFERENCE TO RELATED APPLICATIONS

This patent application claims the benefit of U.S. Provisional Patent Application No. 61/769,097, filed Feb. 25, 2013, entitled “WLAN/3GPP Cellular Network Interworking Including RAN Extensions,” which is incorporated herein by reference in its entirety.

### BACKGROUND

1. Field

This application relates generally to wireless communications, including the inter-system offloading within a communication environment.

2. Related Art

The cellular network industry and service providers have been developing inter-system offloading solutions to alleviate congestion within communication environments by delivering data originally targeted for cellular networks to one or more other complementary technologies such as Wi-Fi. Inter-system offloading can reduce congestion issues and provide flexible bandwidth for load-balancing.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates an example network environment.

FIG. 2 illustrates a base station according to an exemplary embodiment of the present disclosure.

FIG. 3 illustrates an access point according to an exemplary embodiment of the present disclosure.

FIG. 4 illustrates a mobile device according to an exemplary embodiment of the present disclosure.

FIG. 5 illustrates a flowchart of an offloading method according to an exemplary embodiment of the present disclosure.

The embodiments of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

In the following disclosure, terms defined by the Long-Term Evolution (LTE) standard are sometimes used. For example, the term “eNodeB” or “eNB” is used to refer to what is commonly described as a base station (BS) or a base transceiver station (BTS) in other standards. The term “User Equipment (UE)” is used to refer to what is commonly described as a mobile station (MS) or mobile terminal in other standards. The LTE standard is developed by the 3rd Generation Partnership Project (3GPP) and described in the 3GPP specification and International Mobile Telecomunnications-2000 (IMT-2000) standard, all of which are incorporated by reference in their entirety. Further, 3GPP refers to a communication network as a UTRAN (Universal Mobile Telecommunication System (UMTS) Terrestrial Radio Access Network, a E-UTRAN (Evolved UTRAN), and/or a GERAN (Global System for Mobile Communications (GSM) Enhanced Data rates for GSM Evolution (EDGE) Radio Access Network) to provide some examples.

Although exemplary embodiments are described with reference to LTE, the more generic terms “mobile device” and “base station” are used herein except where otherwise noted to refer to the LTE terms “User Equipment (UE)” and “eNodeB/eNB,” respectively.

As will be apparent to one of ordinary skill in the relevant art(s) based on the teachings herein, exemplary embodiments are not limited to the LTE standard, and can be applied to other cellular communication standards, including (but not limited to) Evolved High-Speed Packet Access (HSPA+), Wideband Code Division Multiple Access (W-CDMA), CDMA2000, Time Division-Synchronous Code Division Multiple Access (TD-SCDMA), Global System for Mobile Communications (GSM), General Packet Radio Service (GPRS), Enhanced Data Rates for GSM Evolution (EDGE), and Worldwide Interoperability for Microwave Access (WiMAX) (IEEE 802.16) to provide some examples. Further, exemplary embodiments are not limited to cellular communication networks and can be used or implemented in other kinds of wireless communication access networks, including (but not limited to) WLAN (IEEE 802.11), Bluetooth, Near-field Communication (NFC) (ISO/IEC 18092), ZigBee (IEEE 802.15.4), and/or Radio-frequency identification (RFID), to provide some examples. These various standards and/or protocols are each incorporated by reference in their entirety.

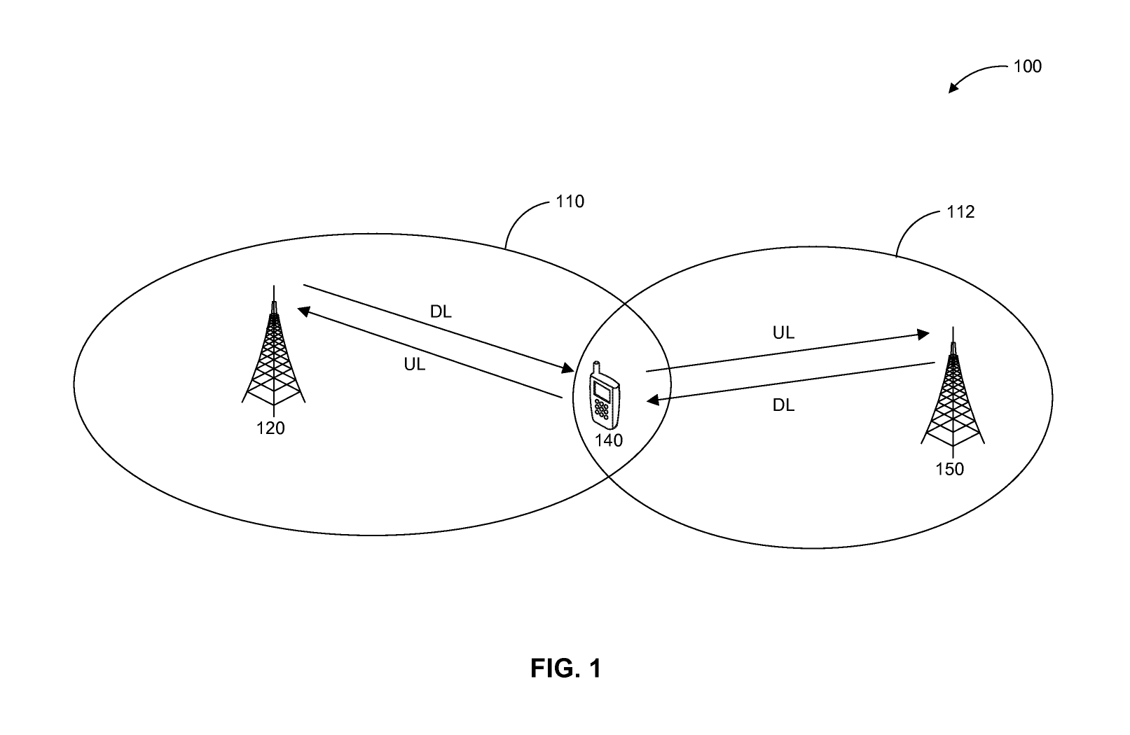

FIG. 1 illustrates an example communication environment 100 that includes a base station 120, a mobile device 140, and an access point (AP) 150. The base station 120, mobile device 140, and AP 150 each include suitable logic, circuitry, and/or code that is configured to communicate via one or more wireless technologies, and the mobile device 140 is further configured to support co-existing wireless communications. The mobile device 140 can include, for example, a transceiver having suitable logic, circuitry, and/or code that is configured to transmit and/or receive wireless communications via one or more wireless technologies within the communication environment 100. The base station 120 and AP 150 each include suitable logic, circuitry, and/or code that is configured to: (1) receive one or more wired communications via one or more well-known wired technologies (e.g., within a core (backhaul) network) and transmit one or more corresponding wireless communications via one or more wireless technologies within the communication environment 100, (2) receive one or more wireless communications within the communication environment 100 via one or more wireless technologies and transmit one or more corresponding wired communications via one or more well-known wired technologies within a core network, and (3) to transmit and/or receive wireless communications via one or more wireless technologies within the communication environment 100. The wireless technologies can include one or more wireless protocols discussed above.

The mobile device 140 can be configured to communicate with the base station 120 in a serving cell or sector 110 of the communication environment 100, and/or to communicate with the access point (AP) 150 in a wireless local area network (WLAN) 112. For example, the mobile device 140 receives signals on one or more downlink (DL) channels and transmits signals to the base station 120 and/or the AP 150 on one or more respective uplink (UL) channels.

In exemplary embodiments of the present disclosure, and as discussed in detail below, the communication environment 100 can utilize inter-system offloading between 3GPP and non-3GPP access networks. For example, the communication environment 100 can be configured to offload wireless communications within a Long-Term Evolution (LTE) access network to a wireless local area network (WLAN), offload wireless communications within a WLAN to a LTE, or a combination of both. Here, the mobile device 140 can be configured to offload one or more communications from a 3GPP access network to a non-3GPP access network, from a non-3GPP access network to a 3GPP access network, or a combination of both. For example, the mobile device 140 can be configured to offload one or more communication within a LTE access network to a WLAN access network.

Further, those skilled in the relevant art(s) will understand that the inter-system offloading is not limited to offloading between 3GPP and non-3GPP access networks, and the offloading can include offloading between a first 3GPP access network and a second 3GPP access network, between a first non-3GPP access network and a second non-3GPP access network, and/or a combination of both. Further, for the purpose of this discussion, inter-system offloading is described from the perspective of offloading communication from the base station 120 to the AP 150. However, it will be understood by those skilled in the relevant art(s) that the offloading is not limited to this perspective and that communications can be offloaded from the AP 150 to the base station 120.

In an exemplary embodiment, the base station 120 includes suitable logic, circuitry, and/or code that is configured for communications conforming to 3GPP's Long-Term Evolution (LTE) specification (e.g., the base station is an LTE base station), the AP 150 includes suitable logic, circuitry, and/or code that is configured for communications conforming to IEEE's 802.11 WLAN specification (e.g., the AP 150 is a WLAN access point), and the mobile device 140 includes suitable logic, circuitry, and/or code that is configured for communications conforming to 3GPP's LTE specification and IEEE's 802.11 WLAN specification. That is, the mobile device 140 is configured to wirelessly communicate with the base station 120 utilizing 3GPP's LTE specification and with the AP 150 utilizing IEEE's 802.11 WLAN specification. Here, the serving cell or sector 110 is an LTE serving cell or sector and the WLAN 112 is a WLAN utilizing the 802.11 WLAN specification. Those skilled in the relevant art(s) will understand that the base station 120, the AP 150, and the mobile device 140 are not limited to these exemplary 3GPP and non-3GPP wireless protocols, and the base station 120, the AP 150, and/or the mobile device 140 can be configured for wireless communications conforming to one or more other 3GPP and/or non-3GPP wireless protocols in addition to, or in the alternative to, the wireless protocols discussed herein.

Examples of the mobile device 140 include (but are not limited to) a mobile computing device-such as a laptop computer, a tablet computer, a mobile telephone or smartphone, a “phablet,” a personal digital assistant (PDA), mobile media player, and the like; and a wearable computing device-such as a computerized wrist watch or “smart” watch, computerized eyeglasses, and the like. In some embodiments, the mobile device 140 may be a stationary device, including, for example, a stationary computing device-such as a personal computer (PC), a desktop computer, a computerized kiosk, an automotive/aeronautical/maritime in-dash computer terminal, and the like.

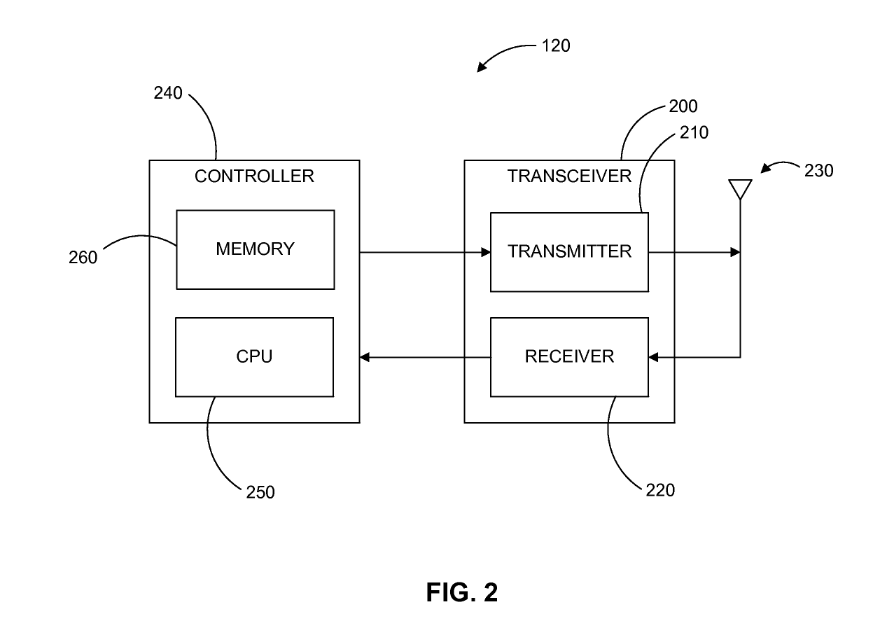

FIG. 2 illustrates the base station 120 according to an exemplary embodiment of the present disclosure. For example, the base station 120 can include a transceiver 200 communicatively coupled to a controller 240.

The transceiver 200 includes suitable logic, circuitry, and/or code that is configured to transmit and/or receive wireless communications via one or more wireless technologies within the communication environment 100. In particular, the transceiver 200 can include a transmitter 210 and a receiver 220 that have suitable logic, circuitry, and/or code configured to transmit and receive wireless communications, respectively, via one or more antennas 230. Those skilled in the relevant art(s) will recognize that the processes for transmitting and/or receiving wireless communications can include (but are not limited to) digital signal processing, modulation and/or demodulation of data, digital-to-analog (DAC) and/or analog-to-digital (ADC) conversion, and/or frequency conversion to provide some examples. Further, those skilled in the relevant art(s) will recognize that the antenna 230 may include an integer array of antennas, and that the antenna 230 may be capable of both transmitting and receiving wireless communication signals. For example, the base station 120 can be configured for wireless communication utilizing a Multiple-input Multiple-output (MIMO) configuration.

In an exemplary embodiment, the transceiver 200 is configured for wireless communications conforming to one or more wireless protocols defined by 3GPP. For example, the transceiver 200 is configured for wireless communications conforming to 3GPP's LTE specification. In this example, the transceiver 200 can be referred to as LTE transceiver 200. It should be appreciated that the transceiver 200 can be referred to by another 3GPP protocol in embodiments where the transceiver 200 is configured for such other communications conforming to the other 3GPP protocol.

The controller 240 includes suitable logic, circuitry, and/or code that is configured to control the overall operation of the base station 120, including the operation of the transceiver 200. The controller 240 can include one or more processors (CPUs) 250 configured to carry out instructions to perform arithmetical, logical, and/or input/output (I/O) operations of the base station 120 and/or one or more components of the base station 120. The controller 240 can further include a memory 260 that includes suitable logic, circuitry, and/or code that is configured to store data and/or instructions. The memory 260 can be any well-known volatile and/or non-volatile memory, including, for example, read-only memory (ROM), random access memory (RAM), flash memory, a magnetic storage media, an optical disc, erasable programmable read only memory (EPROM), programmable read only memory (PROM) and the like. The memory 260 can be non-removable, removable, or a combination of both.

In exemplary embodiments of the present disclosure, the base station 120 is configured to control the offloading of communications by the mobile device 140. For example, the controller 240 is configured to generate one or more offloading commands and to provide the offloading command(s) to the mobile device 140. The offloading command(s) instruct the mobile device 140 to offload communications from one or more 3GPP protocols to one or more non-3GPP wireless protocols, from one or more non-3GPP wireless protocols to one or more 3GPP protocols, from one or more 3GPP protocols to one or more other 3GPP protocols, from one or more non-3GPP protocols to one or more other non-3GPP protocols, or any combination thereof. In an exemplary embodiment, the one or more offloading commands are generated and provided to the mobile device 140 in response to the receipt of one or more supported wireless reports from the mobile device 140 by the base station 120. As discussed in more detail below, the support wireless reports indicate one or more wireless capabilities of the mobile device 140. The offloading commands can be stored in the memory 260, and accessed and executed by the CPU 250 to effectuate the offloading of communications.

In exemplary embodiments, the offloading commands can include one or more measurement commands that instruct the mobile device 140 to gather network information of one or more available communication networks and provide the gathered information to the base station 120. Further, the measurement commands can instruct the mobile device 140 to generate a measurement report that includes the gathered information. The measurement reports are described in more detail below. The controller 240 can be configured to receive and/or process the gathered information and/or the measurement report (including gathered information). The controller 240 can be configured to determine whether the mobile device 140 should offload communications to one or more other communication networks based on the gathered information and/or measurement reports received by the base station 120. Following the offloading determination by the base station 120, the base station 120 can provide another offloading command to the mobile device 140 to instruct the mobile device 140 to offload communications to the other communication network(s). For example, the controller 240 can be configured to generate and provide a first command (e.g., measurement command) to the mobile device 140 to instruct the mobile device 140 to gather network information and provide the gathered information to the base station 120. The controller 240 can then generate and provide a second command (e.g., an offload command) to instruct the mobile device 140 to offload communications to another communication network (e.g., to AP 150).

In exemplary embodiments, the base station 120 can be configured to instruct the mobile device 140 to, for example, power on or off one or more wireless transceivers, scan for and/or identify one or more prospective communication networks that may be conducive for wireless communications, measure one or more network characteristics of one or more identified communication networks, analyze the one or more network characteristics of the identified communication network(s), and/or provide the gathered information to the base station 120.

In exemplary embodiments, the base station 120 can restrict which wireless communication networks can be utilized by the mobile device 140. For example, the controller 240 can be configured to select one or more wireless communication networks that are approved for use by the mobile device 140 to generate a list of approved network(s). The list of the one or more approved networks can then be provided to the mobile device 140. The list can be stored in memory 260 and accessed and executed by the CPU 250. For example, the base station 120 can provide the mobile device 140 (e.g., via LTE) a list of one or more wireless communication networks (e.g., non-3GGP wireless access points) that the mobile device 140 is authorized to use for possible wireless communications. The list can be stored in the memory 460, and accessed and executed by the CPU 450 to effectuate the gathering of information of one or more authorized communication networks. Further, the list of authorized networks can be generated by the controller 240 based on the location and/or movement of the mobile device 140. For example, the authorized networks can be limited to networks in proximity to the current location of the mobile device 140. In an exemplary embodiment. the authorized network list can be broadcast by the base station 120 to one or more mobile devices.

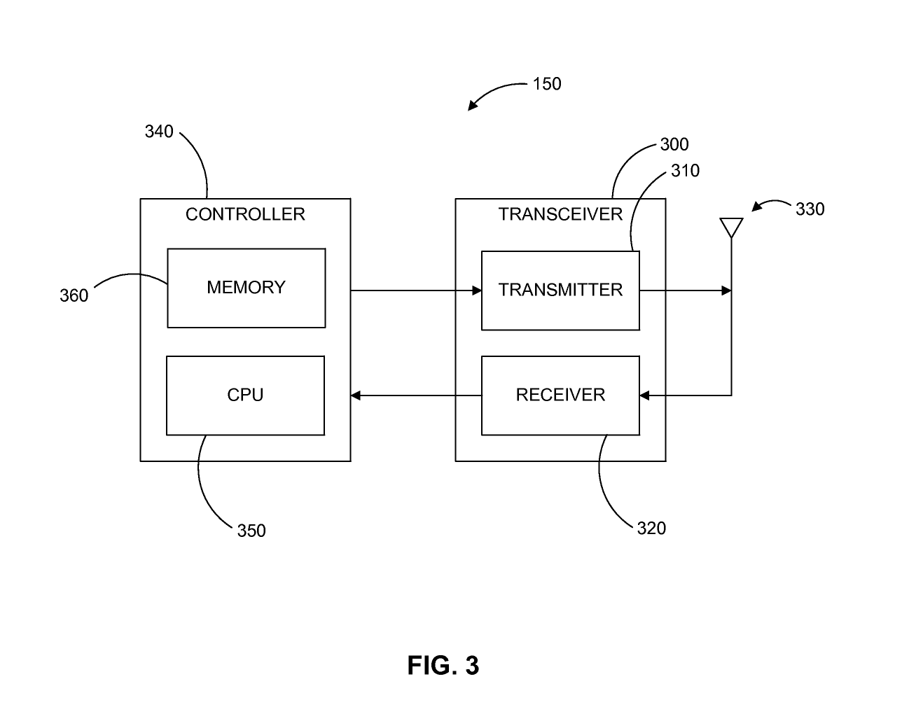

FIG. 3 illustrates the access point (AP) 150 according to an exemplary embodiment of the present disclosure. For example, the AP 150 can include a transceiver 300 communicatively coupled to a controller 340.

The transceiver 300 is similar to the transceiver 200 and includes suitable logic, circuitry, and/or code that is configured to transmit and/or receive wireless communications via one or more wireless technologies within the communication environment 100. In particular, the transceiver 300 can similarly include a transmitter 310 and a receiver 320 that have suitable logic, circuitry, and/or code configured to transmit and receive wireless communications, respectively, via one or more antennas 330. Those skilled in the relevant art(s) will recognize that the antenna 330 may include an integer array of antennas, and that the antenna 330 may be capable of both transmitting and receiving wireless communication signals. For example, the AP 150 can be configured for wireless communication utilizing a Multiple-input Multiple-output (MI MO) configuration.

In an exemplary embodiment, the transceiver 300 is configured for wireless communications conforming to one or more non-3GPP protocols. For example, the transceiver 300 is configured for wireless communications conforming to IEEE's 802.11 WLAN specification. Here, the transceiver 300 can be referred to as WLAN transceiver 300.

The controller 340 is similar to the controller 240 and includes suitable logic, circuitry, and/or code that is configured to control the overall operation of the AP 150, including the operation of the transceiver 300. The controller 340 can include one or more processors (CPUs) 350 configured to carry out instructions to perform arithmetical, logical, and/or input/output (I/O) operations of the AP 150 and/or one or more components of the AP 150. The controller 340 can further include a memory 360 that includes suitable logic, circuitry, and/or code that is configured to store data and/or instructions. The memory 360 can be any well-known volatile and/or non-volatile memory similar to the memory 260 described above. Similarly, the memory 360 can be non-removable, removable, or a combination of both.

In exemplary embodiments of the present disclosure, the AP 150 is configured to control the offloading of communication by the mobile device 140. For example, the controller 340 is configured to generate one or more offloading commands and to provide the offloading command(s) to the mobile device 140. The offloading command(s) instruct the mobile device 140 to offload communication from one or more 3GPP protocols to one or more non-3GPP wireless protocols, from one or more non-3GPP wireless protocols to one or more 3GPP protocols, from one or more 3GPP protocols to one or more other 3GPP protocols, from one or more non-3GPP protocols to one or more other non-3GPP protocols, or any combination therefrom. In an exemplary embodiment, the one or more offloading commands are generated and provided to the mobile device 140 in response to the receipt of one or more supported wireless reports from the mobile device 140 by the AP 150. The offloading commands can be stored in the memory 360, and accessed and executed by the CPU 350 to effectuate the offloading of communications. It will be understood by those skilled in the relevant art(s) that the AP 150 (including controller 340) can be similarly configured as discussed above with respect to the offloading process (including related processes) performed by the base station 120. For brevity, this similar discussion has been omitted from this disclosure.

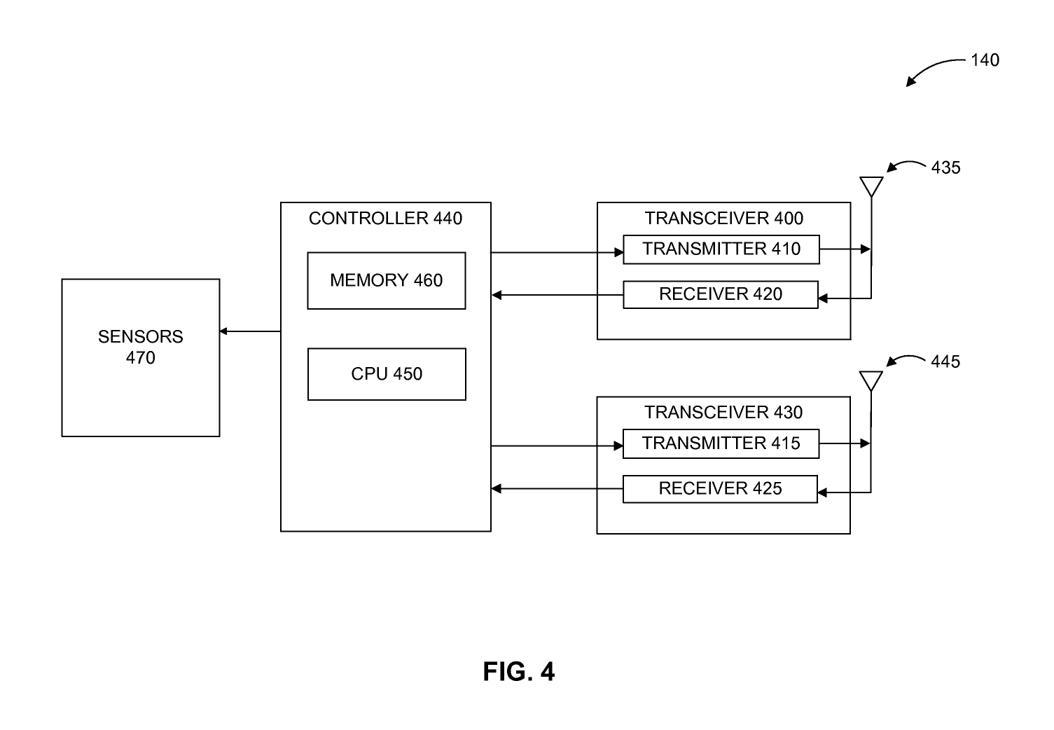

FIG. 4 illustrates the mobile device 140 according to an exemplary embodiment of the present disclosure. The mobile device 140 can include a controller 440 communicatively coupled to an LTE transceiver 400 and a WLAN transceiver 430. The mobile device 140 can be configured for wireless communications conforming to one or more wireless protocols defined by 3GPP and/or one or more non-3GPP wireless protocols. In an exemplary embodiment, the mobile device 140 is configured for wireless communication conforming to 3GPP's LTE specification and for wireless communication conforming to IEEE's 802.11 WLAN specification. Those skilled in the relevant art(s) will understand that the mobile device 140 is not limited to these exemplary 3GPP and non-3GPP wireless protocols, and the mobile device 140 can be configured for wireless communications conforming to one or more other 3GPP and/or non-3GPP wireless protocols in addition to, or in the alternative to, the wireless protocols discussed herein.

The LTE transceiver 400 includes suitable logic, circuitry, and/or code that is configured for transmitting and/or receiving wireless communications conforming to 3GPP's LTE specification. In particular, the LTE transceiver 400 can include an LTE transmitter 410 and an LTE receiver 420 that have suitable logic, circuitry, and/or code configured for transmitting and receiving wireless communications conforming to 3GPP's LTE specification, respectively, via one or more antennas 435. Transceiver 400 need not be limited to LTE, and could operate according to another cellular standard, as will be understood by those skilled in art.

The WLAN transceiver 430 includes suitable logic, circuitry, and/or code that is configured for transmitting and/or receiving wireless communications conforming to IEEE's 802.11 WLAN specification. In particular, the WLAN transceiver 430 can include a WLAN transmitter 415 and a WLAN receiver 425 that have suitable logic, circuitry, and/or code configured for transmitting and receiving wireless communications conforming to IEEE's 802.11 WLAN specification, respectively, via one or more antennas 445.

Regarding the LTE transceiver 400 and the WLAN transceiver 430, the processes for transmitting and/or receiving wireless communications can include (but are not limited to) digital signal processing, modulation and/or demodulation of data, DAC and/or ADC conversion, and/or frequency conversion to provide some examples. Further, those skilled in the relevant art(s) will recognize that antennas 435 and/or 445 may include an integer array of antennas, and that the antennas may be capable of both transmitting and receiving wireless communication signals.

The controller 440 includes suitable logic, circuitry, and/or code that is configured to control the overall operation of the mobile device 140, including the operation of the LTE transceiver 400 and WLAN transceiver 430. The controller 440 can include one or more processors (CPUs) 450 configured to carry out instructions to perform arithmetical, logical, and/or input/output (I/O) operations of the mobile device 140 and/or one or more components of the mobile device 140. The controller 440 can further include a memory 460 that is similar to memories 260 and 360, and includes suitable logic, circuitry, and/or code that is configured to store data and/or instructions. Similarly, the memory 460 can be any well-known volatile and/or non-volatile memory, and can be non-removable, removable, or a combination of both.

In an exemplary embodiment, the mobile device 140 includes one or more other transceivers configured to communicate via one or more well-known communication technologies (e.g., CDMA, GSM, or the like). The one or more other transceivers can also be configured for navigational purposes utilizing one or more well-known navigational systems, including the Global Navigation Satellite System (GNSS), the Russian Global Navigation Satellite System (GLONASS), the European Union Galileo positioning system (GALILEO), the Japanese Quasi-Zenith Satellite System (QZSS), the Chinese BeiDou navigation system, and/or the Indian Regional Navigational Satellite System (IRNSS) to provide some examples. Further, the mobile device 140 can include one or more positional and/or movement sensors 470 (e.g., GPS, accelerometer, gyroscope sensor, etc.) implemented in (and/or in communication with) the mobile device 140. Here, the location and/or movement of the mobile device 140 can be determined using one or more transceivers configured for navigation purposes, one or more of the positional and/or movement sensors 470, and/or one or more positional determinations using signal characteristics relative to one or more base stations and/or access points.

In exemplary embodiments of the present disclosure, the controller 440 is configured to determine one or more wireless capabilities of the mobile device 140 (e.g., capability information) and to provide the determined wireless capabilities to one or more service providers (e.g., base station 120). For example, the mobile device 140 can be configured for wireless communications conforming to one or more wireless protocols defined by 3GPP and/or one or more non-3GPP wireless protocols. In an exemplary embodiment, the mobile device 140 is configured for wireless communication conforming to 3GPP's LTE specification and for wireless communication conforming to IEEE's 802.11 WLAN specification. In this case, the mobile device 140 can determine that the mobile device 140 is configured for WLAN communication in addition to (or alternatively to) LTE communications and provide the determined capability to the base station 120 (e.g., the service provider) in the form of, for example, capability information.

Further, the mobile device 140 is configured to generate a supported wireless report that includes one or more 3GPP and/or non-3GPP wireless protocols that are supported by the mobile device 140. The supported wireless report can then be provided to the one or more service providers (e.g., to base station 120) to indicate the one or more 3GPP and/or non-3GPP wireless protocols that are supported by the mobile device 140. The determination of wireless capabilities of the mobile device 140, the generation of the supported wireless report, and the proving of the supported wireless report to the service provider(s) can collectively be referred to as wireless capability processing.

In an exemplary embodiment, the mobile device 140 is configured to determine the wireless capabilities of the mobile device 140, generate the supported wireless report, and provide the supported wireless report to the service provider(s) (e.g., base station 120) upon the powering up of the mobile device 140 to a powered-on state and/or during the transition to the powered-on state. The powering up of the mobile device can be from a powered-off state, a standby state, a sleep state, and/or any other power state as would understood by those of ordinary skill in the relevant art(s). It should also be appreciated that the wireless capabilities processing can be upon the powering down of the mobile device 140 to, and/or during the transition to, a power state that is lower than the powered-on state. In exemplary embodiments, wireless capability processing can be scheduled to be performed at one or more predetermined times of day, dates, or the like. The scheduled wireless capability processing can be scheduled by the base station 120, AP 150, and/or the mobile device 140.

In exemplary embodiments, the mobile device 140 can be configured to perform wireless capability processing in response to one or more commands from the service provider(s) (e.g., base station 120), based on the movement and/or position of the mobile device 140, based on one or more wireless characteristics of one or more communication networks (including currently connected and/or prospective network(s)), and/or any other contextual and/or environmental information as would be apparent to those skilled in the relevant art(s).

In exemplary embodiments of the present disclosure, one or more service providers (e.g., base station 120) associated with the mobile device 140 are configured to provide one or more offloading commands to the mobile device 140 to instruct the mobile device 140 to offload communication from one or more 3GPP protocols to one or more non-3GPP wireless protocols, from one or more non-3GPP wireless protocols to one or more 3GPP protocols, from one or more 3GPP protocols to one or more other 3GPP protocols, from one or more non-3GPP protocols to one or more other non-3GPP protocols, or any combination therefrom. In an exemplary embodiment, the one or more offloading commands are generated and provided to the mobile device 140 in response to the service provider(s) receipt of one or more supported wireless reports from the mobile device 140.

In exemplary embodiments of the present disclosure, the mobile device 140 is configured to offload communication from one or more 3GPP protocols to one or more non-3GPP wireless protocols, from one or more non-3GPP wireless protocols to one or more 3GPP protocols, from one or more 3GPP protocols to one or more other 3GPP protocols, from one or more non-3GPP protocols to one or more other non-3GPP protocols, or any combination therefrom. For example, the mobile device 140 can be configured to offload communications from one of the LTE or Wi-Fi transceivers 400, 430 to the other of the LTE and Wi-Fi transceivers 400, 430. The offloading can be based on one or more offloading commands provided to the mobile device 140 by one or more service providers (e.g., base station 120) and received via the LTE transceiver 400 and/or the Wi-Fi transceiver 430. That is, the offloading can be at the behest of the one or service providers (e.g., base station 120) and effectuated by the mobile device 140 in response to one or more offloading commands received by the mobile device from the one or more service providers (e.g., base station 120). Further, the offloading commands can be stored in the memory 460, and accessed and executed by the CPU 450 to effectuate the offloading of communications. For example, the controller 440 can be configured to control the mobile device 140 to offload communications with the base station 120 to the AP 150 based on one or more of the offloading commands.

In exemplary embodiments, the offloading commands can include one or more measurement commands that instruct the mobile device 140 to gather network information of one or more available communication networks and provide the gathered information to the one or more service providers. The mobile device 140 can be configured to generate a measurement report that includes the gathered information in response to one or more offloading commands. The gathered information and/or the measurement report (including gathered information) can then be reported to the service provider(s) (e.g., base station 120). The service provider(s) (e.g., base station 120) can then use the gathered information to determine whether the mobile device 140 should offload communications to one or more other communication networks. Following the determination by the service provider(s) (e.g., base station 120), the service provider(s) can provide another offloading command to the mobile device 140 to instruct the mobile device 140 to offload communications to the other communication network(s). For example, the base station 120 can provide a first command to the mobile device 140 to instruct the mobile device 140 to gather network information and provide the gathered information to the base station 120. The base station 120 can then provide a second command to instruct the mobile device 140 to offload communications to another communication network (e.g., to AP 150). In an exemplary embodiment, the gathering of network information and providing of such information is performed automatically in the background of the operating system of the mobile device 140 and does not require interaction from a user of the mobile device 140.

In gathering network information, the mobile device 140 can be configured to (but is not limited to), for example, power on or off one or more wireless transceivers, scan for and/or identify one or more prospective communication networks that may be conducive for wireless communications, measure one or more network characteristics of one or more identified communication networks, analyze the one or more network characteristics of the identified communication network(s), and/or provide the gathered information to one or more service providers. Further, the gathered information can be stored and/or maintained in a server that is communicatively coupled to the mobile device 140 via one or more of the communication networks.

In exemplary embodiments, the one or more service providers (e.g., base station 120) can restrict which wireless communication networks can be utilized by the mobile device 140. For example, the base station 120 can be configured to provide the mobile device 140 with one or more wireless communication networks that have been approved for use by the mobile device 140. That is, the base station 120 can provide the mobile device 140 (e.g., via LTE) a list of one or more wireless communication networks (e.g., non-3GGP wireless access points) that the mobile device 140 is authorized to use for possible wireless communications. The list can be stored in the memory 460, and accessed and executed by the CPU 450 to effectuate the gathering of information of one or more authorized communication networks. Further, the list of authorized networks can be generated by the service provider(s) (e.g., base station 120) based on the location and/or movement of the mobile device 140. For example, the authorized networks can be limited to networks in proximity to the current location of the mobile device 140. In an exemplary embodiment, the authorized network list can be broadcast by the service provider(s) to one or more mobile devices.

In exemplary embodiments of the present disclosure, the one or more offloading commands provided to the mobile device 140 include one or more Radio Resource Control (RRC) measurements control messages provided to the mobile device 140 by the one or more service providers (e.g., base station 120). A RRC measurements control message contains one or more commands and/or instructions that control the mobile device 140 to gather network information of one or more available communication networks. The RRC measurements control message can also contain one or more commands and/or instructions that control the mobile device 140 to provide the gathered information to one or more service providers. In an exemplary embodiment, the RRC measurements control message instructs the mobile device 140 to power on or off one or more wireless transceivers, scan for and/or identify one or more prospective communication networks that may be conducive for wireless communications, measure one or more network characteristics of one or more identified communication networks, analyze the one or more network characteristics of the identified communication network(s), generate a measurement report including identified network(s), measurement(s), and/or analysis, and/or provide the gathered information and/or measurement report(s) to one or more service providers.

In exemplary embodiments of the present disclosure, the network characteristics can include (but are not limited to), for example:
network identification information,
signal strength information,
noise and/or interference measurements indicative of the noise and/or interference associated with the network(s),
wireless load information,
wide area network (WAN) information (e.g., backbone information) supporting one or more access points,
service provider identification information, supported and/or current data rates of the network(s),
quality of service (QoS) information of the network(s),
network type and/or venue information of the network(s), and/or
any other network characteristic as will be apparent to those of ordinary skill in the relevant art(s) without departing from the spirit and scope of the present disclosure, including, for example, one or more network parameters that are indicative of the condition (e.g., health) of the prospective communication network(s).

In exemplary embodiments, the network identification information can include a HESSID (homogenous extended service set identifier), a BSSID (basic service set identifier), and/or a SSID (service set identifier), to provide some examples. The HESSID is a media access control (MAC) address that is the same on all access points belonging to a particular network. Similarly, the BSSID and SSID are identifiers used to identify the basic service set (e.g., an access point and one or 1 more stations). For example, BSSID uniquely identifies the basic service set (BSS) and is a MAC address of the wireless access point generated by combining the 24 bit Organization Unique Identifier (e.g., the manufacturer's identity) and the manufacturer's assigned 24-bit identifier for the radio chipset in the access point. The SSID is 1 to 32 byte string and is typically a human-readable string commonly called the “network name.” The HESSID, BSSID and SSID are further defined in the IEEE 802.11 standard, which is incorporated herein by reference in its entirety.

The signal strength information can include, for example, a received signal strength indication (RSSI) thresholds (dB) for a wireless connection between the mobile device 140 and one or more prospective communication networks and/or any other well-known parameter indicative of a wireless signal strength as would be understood by those of ordinary skill in the relevant art(s).

The noise and/or interference measurements can include a signal-to-interference-plus-noise ratio (SINR) indicative of the noise and/or interference associated one or more prospective communication networks and/or any other well-known parameter indicative of noise and/or interference within wireless environment as would be understood by those of ordinary skill in the relevant art(s).

The wireless load information can include, for example, the population of other mobile devices utilizing one or more prospective wireless communication networks, the channel utilization of the prospective network(s), and/or any other well-known parameter indicative of load and/or congestion associated with one or more wireless environments as would be understood by those of ordinary skill in the relevant art(s).

The wide area network (WAN) information can include any information regarding the wide area network (WAN) link supporting one or more wireless access points corresponding to one or more prospective communication networks. That is, the WAN information includes information regarding the backbone network supporting a particular wireless access point. In an exemplary embodiment, the WAN link information includes WAN metrics that conform to, or is associated with, the Access Network Query Protocol (ANQP) as defined in the IEEE 802.11u standard, which is incorporated herein by reference in its entirety.

The service provider identification information can include, for example, identification information that identifies the service provider(s) associated with one or more prospective communication networks.

The quality of service (QoS) information can include, for example, information indicative of the QoS offered by one or more prospective communication networks. In an exemplary embodiment, the QoS information includes WLAN multimedia (WMM) mapping information. The WMM information can include (but is not limited to), for example, packet priority information, packet error loss rate information and/or packet delay budget information. Further, in exemplary embodiments, the WMM information is similar to the QoS Class Identifier (QCI) mapping defined in the 3GPP specification. Using the WWM information, the mobile device 140 can determine whether the prospective wireless communication network(s) will provide the same or better QoS as the LTE network, which typically provides low latency for Real-time Transport Protocol (RTP) traffic (e.g., voice and/or video traffic). In an exemplary embodiment, the QoS information can include estimated data rate information of one or more prospective communication networks. Here, one or more wireless access points can be configured to estimate the data rate on the wireless medium and the channel utilization using any well-known date rate and/or channel utilization estimation processes that would be understood by those skilled in the relevant art(s), including, for example, estimations based on the “average cycle time” approach discussed in “Throughput Analysis of IEEE 802.11 Wireless LANs using Average Cycle Time Approach,” K. Medepalli and F. A. Tobagi, Proceedings of IEEE Globecom 2005, and discussed in U.S. patent application Ser. No. 14/149,390, filed Jan. 7, 2014, entitled “Mobile Device With Cellular-WLAN Offload Using Passive Load Sensing Of WLAN,” each of which is incorporated herein by reference in its entirety.

The network type information can include, for example, information identifying the network type for one or more prospective communication networks. The network type can include, for example, a public network, a free network, a personal network, an emergency network, a government network, and/or any other network type as would be understood by those of ordinary skill in the relevant art(s).

The venue information can include, for example, information identifying the venue in which one or more other prospective communication networks is deployed. The venue information can include, for example, a residence, a commercial space (e.g., business), a hospital, a hotel, a school, a municipal space, and/or any other venue type as would be understood by those of ordinary skill in the relevant art(s). The venue can be helpful in determining the wireless coverage of an associated network. For example, for venue information indicating that the network is deployed in a municipal space or school, the venue information may indicate that the communication network may possibly be an extended communication network (e.g., Municipal wireless networks, campus-wide networks, or the like) that offers continuous coverage over multiple access points.

In exemplary embodiments, the mobile device 140 can alternatively, or additionally, be configured to offload communications to one or more other communication networks based on one or more operational parameters, policies, and/or conditions provided to the mobile device 140 by one or more service providers. Herein, the operational parameters, policies, and/or conditions can be collectively referred to as an operational framework. The operational framework can be received by the mobile device 140 via, for example, the LTE transceiver 400 and/or the Wi-Fi transceiver 430, and/or can be pre-installed and/or periodically updated, for example, by the service provider and/or mobile device manufacture. Here, the operational framework can provide guidance to the mobile device 140 as to when to offload communications. That is, in exemplary embodiments where the mobile device 140 utilizes an operational framework, the mobile device 140 is configured to determine whether to perform a handover operation (e.g., to offload communications) to one or more other communication networks rather than, or in addition to, performing a handover operation at the behest of the service provider(s) and in response to one or more offloading commands. The operational framework can be stored in the memory 460, and accessed and executed by the CPU 450 to effectuate the offloading of communications. For example, the controller 440 can be configured to control the mobile device 140 to offload communications with the base station 120 to the AP 150 (or vice versa) based on one or more offloading policies defined by the operational framework.

In an exemplary embodiment, the operational framework can define the one or more the network characteristics that are to be gathered by the mobile device 140 in response to one or more offloading commands provided to the mobile device 140. That is, the one or more offloading commands can include the operation framework that defines which network characteristics are to be gathered by the mobile device 140 and provided to the one or more service providers.

In operation, the operational framework can define, for example, one or more communication networks that can be used by the mobile device 140, one or more policies for inter-system offloading between one or more 3GPP and/or non-3GPP communication networks, and/or one or more network characteristics that are to be gathered by the mobile device 104 and provided to the one or more service providers. The inter-system offloading policies can be used to control the offloading of communications by the mobile device 140, including, for example, the offloading of communications from the base station 120 to the AP 150, from the AP 150 to the base station 120, or a combination of both. For example, the mobile device 140 can be configured to offload communications with the base station 120 to the AP 150 based on one or more inter-system offloading policies defined in the operational framework that is provided to the mobile device 140 by the one or more service providers. In an exemplary embodiment, the operational framework can be maintained in a server that is communicatively coupled to the mobile device 140 via one or more communication networks associated with the one or more service providers.

In an exemplary embodiment, the operational framework is an extension of the Access Network Discovery and Selection Function (ANDSF) framework as defined in the 3GPP TS 24.312 specification, which is incorporated herein by reference in its entirety. The ANDSF framework is an entity introduced by 3GPP as part of the Release 8 set of specifications, within an Evolved Packet Core (EPC) of the System Architecture Evolution (SAE) for 3GPP compliant communication networks. The ANDSF framework assists the mobile device 140 to discover one or more non-3GPP communication networks (e.g., WLAN, WIMAX, etc.) that can be used for data communications in addition to one or more 3GPP communication networks (e.g., LTE, HSPA, etc.) and to provide the mobile device 140 with rules (e.g., policy conditions) that control the connection to the 3GPP and/or non-3GPP communication networks. The use of operational parameters, policies, and/or conditions within an operational framework for inter-system offloading, and the transmission of the operational framework to a mobile device, is further described in U.S. patent application Ser. No. 14/149,681 filed Jan. 7, 2014, entitled “Systems And Methods For Network Discovery And Selection Using Contextual Information,” and U.S. patent application Ser. No. 14/167,615 filed Jan. 29, 2014, entitled “System And Methods For Anonymous Crowdsourcing Of Network Condition Measurements,” each of which is incorporated herein by reference in its entirety.

The ANDSF framework is defined by one or more ANDSF Management Objects (MO) that are generated by the service providers of the one or more 3GPP communication networks and provided to the mobile device 140. The ANDSF MOs of the framework can provide the mobile device 140 with the following information, based on the service provider's configuration:
1. Inter-System Mobility Policy (ISMP)—network selections rules for a mobile device with no more than one active communication network connection (e.g., either LTE or WLAN).
2. Inter-System Routing Policy (ISRP)—network selection rules for the mobile device with potentially more than one active communication network connection (e.g., both LTE and WLAN). Here, the mobile device may employ IP Flow Mobility (IFOM), Multiple Access Packet Data Networks (PDN) Connectivity (MAPCON) or non-seamless WLAN offloading according to operator policy and user preferences.
3. Discovery Information—a list of networks that may be available in the vicinity of the mobile device and information assisting the mobile device to expedite the connection to these networks.
4. Network Information—the network information and/or other types of information that is to be gathered by the mobile device.

Here, the ANDSF framework assists the mobile device 140 to discover communication networks in the vicinity of the mobile device 140 and prioritize/manage connections to the communication networks, as well as provide one or more parameter associated with network information to be gathered. The policies set forth in the ANDSF framework can be statically pre-configured on the mobile device or dynamically updated by the service provider and provided to the mobile device 140 via the Open Mobile Alliance (OMA) Device Management (DM) protocol specified by the OMA DM Working Group and the Data Synchronization (DS) Working Group. The OMA DM protocol is incorporated herein by reference in its entirety.

The ANDSF framework can be referred to as an ANDSF Management Object (MO) that include various rules, conditions, parameters, and other information organized into one or more “nodes” that may have one or more “leaf objects” descending therefrom. The nodes and leaf objects define the various rules, condition, parameters, etc. that are used by the mobile device 140 in governing the ISMP, ISRP, Discovery, and network information gathering by the mobile device 140. For example, the ANDSF MO is used by the mobile device 140 to establish communications via one or more non-3GPP communication networks (e.g., WLAN communication network on AP 150) and effectuate offloading of the mobile device's 140 communications via the base station 120 to, for example, the AP 150. Similarly, the ANDSF MO is used by the service provider to instruct the mobile device 140 what information of the communication networks to gather and provide to the service provider.

The ANDSF MOs can be maintained by an ANDSF server that is communicatively coupled to the mobile device 140 via one or more communication networks associated with the one or more service providers (e.g., via the base station 120). The various rules and information within the ANDSF MO can be either statically pre-configured on the mobile device 140 or dynamically updated by the service provider and provided to the mobile device 140. The ANDSF MO can be stored in the memory 460 of the mobile device 140, and accessed and executed by the CPU 450 to effectuate the ISMP, ISRP, Discovery, network information gathering, and/or offloading processing.

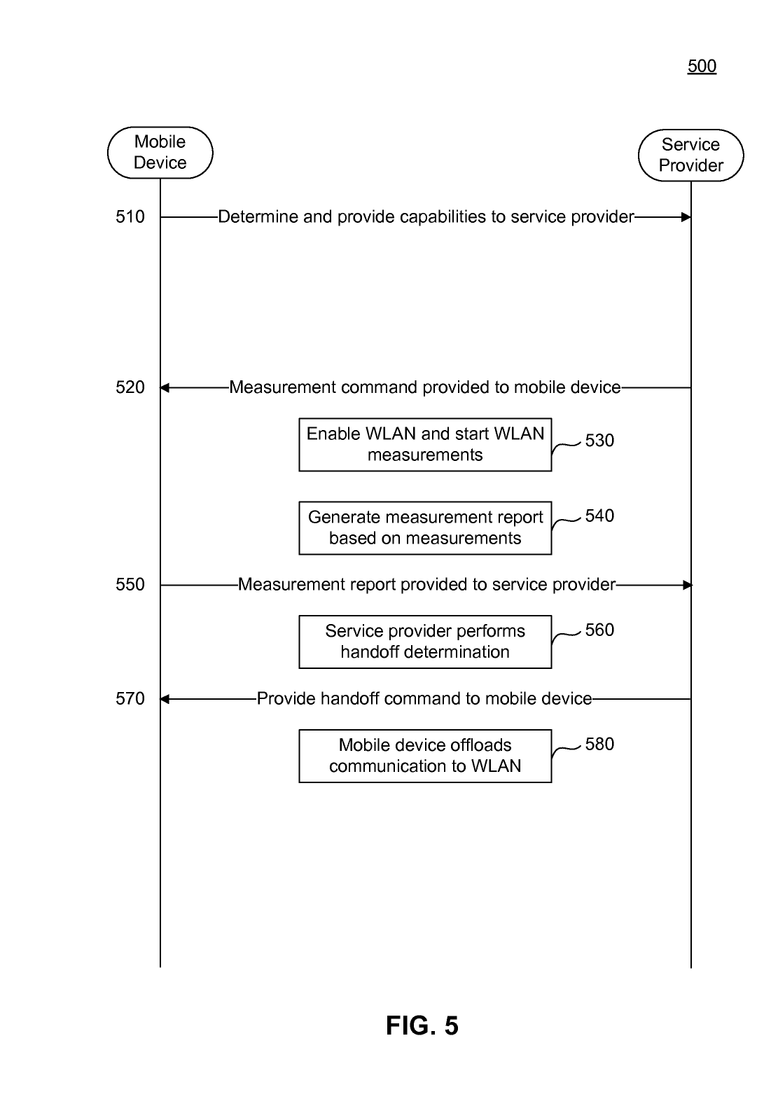

FIG. 5 illustrates a flowchart 500 of an inter-system offloading method in accordance with an exemplary embodiment of the present disclosure. The method of flowchart 500 is described with continued reference to FIGS. 1-4. The steps of the method of flowchart 500 are not limited to the order described below, and the various steps may be performed in a different order. Further, two or more steps of the method of flowchart 500 may be performed simultaneously with each other.

The method of flowchart 500 begins at step 510, where the mobile device 140 performs wireless capability processing. In an exemplary embodiment, the wireless capability processing includes: determining one or more wireless capabilities of the mobile device 140, generating a supported wireless report that is indicative of the wireless capabilities of the mobile device, and providing the supported wireless report to the service provider(s) (e.g., base station 120) utilizing, for example, the LTE transceiver 400. In an exemplary embodiment, the wireless capability processing is performed upon the mobile device 140 entering a powered-on state, during a transition to the powered-on state, or a combination of both. Alternatively, or additionally, the wireless capability processing can be performed during a standby state, sleep state, or any other state having a lower power consumption than the powered-on state.

After step 510, the flowchart 500 transitions to step 520, where one or more service providers (e.g., base station 120) generates one or more measurement commands and provides the measurement command(s) to the mobile device 140. In exemplary embodiments, the measurement commands instruct the mobile device 140 to gather network information of one or more prospective communication networks and provide the gathered information to the one or more service providers. In exemplary embodiments of the present disclosure, the one or more service providers (e.g., base station 120) are configured to provide one or more Radio Resource Control (RRC) measurements control messages to the mobile device 140. A RRC measurements control message contains one or more commands and/or instructions that control the mobile device 140 to gather network information (e.g. RSSI, SINR, SSID, etc.) of one or more available communication networks. In embodiments, the RRC control messages can include or utilize an operational framework, such as ANDSF, to communicate the measurement commands.

After step 520, the flowchart 500 transitions to step 530, where the mobile device 140 gathers network information of one or more prospective communication networks. In exemplary embodiments, the gathering of network information can include (but is not limited to), for example, powering on or off one or more wireless transceivers, scanning for and/or identifying one or more prospective communication networks that may be conducive for wireless communications, measuring one or more network characteristics of one or more identified communication networks, and/or analyzing the one or more network characteristics of the identified communication network(s).

After step 530, the flowchart 500 transitions to step 540, where the mobile device 140 generates one or more measurement reports based on the gathered information. For example, the mobile device 140 can be configured to generate a measurement report that includes one or more identified prospective communication networks, measurements of network characteristics of one or more identified communication networks, and/or analysis of the network characteristic(s) of the identified communication network(s).

After step 540, the flowchart 500 transitions to step 550, where the mobile device 140 provides the one or more measurement reports to one or more service providers (e.g., to base station 120). For example, the mobile device 140 can be configured to transmit the measurement report(s) utilizing the LTE transceiver 400 to the base station 120.

After step 550, the flowchart 500 transitions to step 560, where the service provider(s) (e.g., base station 120) determines whether the mobile device 140 should offload communications to one or more communication networks identified in the received measurement report(s). In an exemplary embodiment, the base station 120 determines whether to offload communications to one or more communication networks based on one or more network characteristics of the identified communication network(s) and/or on the analysis of one or more network characteristics. For example, the base station 120 can select from one or more of the identified networks in which the mobile device 140 is to offload communications to, where the selection can be based on the network characteristic(s) of a respective identified communication network and/or on the analysis of the network characteristic(s).

After step 560, the flowchart 500 transitions to step 570, where the service provider(s) (e.g., base station 120) generates one or more offloading commands based on the offloading determination. The service provider(s) (e.g., base station 120) then provides the offloading command(s) to the mobile device 140. In an exemplary embodiment, the offloading command(s) instructs the mobile device 140 to offload communication to one or more of the communication networks identified by the mobile device 140. For example, the offloading command(s) can indicate one or more networks from the identified networks that have been selected by the base station 120 for the offloading of communications.

After step 570, the flowchart 500 transitions to step 580, where the mobile device 140 offloads communications to one or more of the selected communication networks. For example, the mobile device 140 can offload communications from the base station 120 to the AP 150.

### CONCLUSION

The aforementioned description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventors, and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

What is claimed is:

1. A base station, comprising:
a transceiver configured to communicate with a communication device via a first communication network; and
a controller configured to:
receive one or more network characteristics associated with a second communication network from the communication device; and
provide an offloading command to the communication device to instruct the communication device to offload a communication on the first communication network to the second communication network, wherein the offloading command is based on the received one or more network characteristics.

2. The base station of claim 1, wherein the controller is further configured to:
analyze the one or more network characteristics; and
generate the offloading command based on the analysis of the one or more network characteristics.

3. The base station of claim 1, wherein the controller is further configured to:
generate a measurement command based on capability information received from the communication device, the capability information including one or more wireless capabilities of the communication device; and
provide the measurement command to the communication device to instruct the communication device to provide the one or more network characteristics to the base station.

4. The base station of claim 1, wherein the controller is further configured to:
receive a measurement report generated by the communication device, the measurement report including an identification associated with the second communication network and the one or more network characteristics associated with the second communication network.

5. The base station of claim 4, wherein the measurement report further includes an analysis of the one or more network characteristics associated with the second communication network.

6. The base station of claim 1, wherein the one or more network characteristics comprise: network identification information, signal strength information, a signal-to-interference-plus-noise ratio (SINR), wireless load information, wide area network (WAN) information, service provider identification information, data rate information, quality of service (QoS) information, network type information, or venue information.

7. The base station of claim 1, wherein the controller is further configured to:
select one or more approved communication networks to generate a list of the one or more approved communication networks; and
provide the communication device with the list of the one or more approved communication networks, wherein the second communication network is included in the list of the one or more approved communication networks.

8. The base station of claim 1, wherein the first communication network is a 3rd Generation Partnership Project (3GPP) communication network and the second communication network is a non-3GPP communication network.

9. A method for communicating with a communication device and a base station, the method comprising:
receiving, at the base station, capability information from the communication device via a first communication network, the capability information being associated with a second communication network;
providing a measurement command via the first communication network to the communication device based on the capability information;
receiving one or more network characteristics associated with the second communication network from the communication device based on the measurement command;
determining, by the base station, whether to offload a communication on the first communication network to the second communication network based on the received one or more network characteristics; and
providing an offloading command to the communication device via the first communication network when a determination is made to offload the communication to the second communication network.

10. The method of claim 9, wherein the capability information indicates that the communication device is configured to communicate via the second communication network.

11. The method of claim 9, further comprising:
analyzing the received one or more network characteristics; and
generating the offloading command based on the analysis of the one or more network characteristics.

12. The method of claim 9, further comprising:
receiving a measurement report generated by the communication device, the measurement report including an identification associated with the second communication network and the one or more network characteristics associated with the second communication network.

13. The method of claim 12, wherein the measurement report further includes an analysis of the one or more network characteristics associated with the second communication network.

14. The method of claim 9, wherein the one or more network characteristics comprise: network identification information, signal strength information, a signal-to-interference-plus-noise ratio (SINR), wireless load information, wide area network (WAN) information, service provider identification information, data rate information, quality of service (QoS) information, network type information, or venue information.

15. The method of claim 9, further comprising:
selecting one or more approved communication networks to generate a list of the one or more approved communication networks; and
providing the communication device with the list of the one or more approved communication networks, wherein the second communication network is included in the list of the one or more approved communication networks.

16. The method of claim 9, wherein the first communication network is a 3rd Generation Partnership Project (3GPP) communication network and the second communication network is a non-3GPP communication network.

17. A communication device, comprising:
a first transceiver configured to communicate with a first communication network;
a second transceiver configured to communicate with a second communication network; and
a controller configured to:
provide capability information to a base station associated with the first communication network, the capability information providing an indication that the communication device is able to communicate with the second communication network;
receive a measurement command from the base station, the measurement command being based on the capability information;
provide a measurement report to the base station based on the measurement command;
receive an offloading command from the base station via the first communication network, the offloading command being generated by the base station based on the measurement report; and
control the first transceiver to offload a communication on the first communication network to the second communication network based on the received offloading command.

18. The communication device of claim 17, wherein the controller is further configured to determine the capability information upon the communication device entering a powered-on state.

19. The communication device of claim 17, wherein, in response to the measurement command, the controller is further configured to:
determine one or more network characteristics associated with the second communication network;
analyze the one or more network characteristics; and
generate the measurement report based on the analysis of the one or more network characteristics.

20. The communication device of claim 17, wherein the measurement report includes one or more network characteristics, comprising: network identification information, signal strength information, a signal-to-interference-plus-noise ratio (SINR), wireless load information, wide area network (WAN) information, service provider identification information, data rate information, quality of service (QoS) information, network type information, or venue information.
